(19) United States
(12) Patent Application Publication
(10) Pub. No.: US 2026/0246525 A1
(43) Pub. Date: Aug. 20, 2026

(54) BEAM CONTROL METHOD AND DEVICE FOR DIRECT COMMUNICATION BETWEEN TERMINALS IN WIRELESS COMMUNICATION SYSTEM

(71) Applicant: Samsung Electronics Co., Ltd., Suwon-si, Gyeonggi-do (KR)

(72) Inventors: Kyoungmin PARK, Suwon-si (KR); Hyunseok RYU, Suwon-si (KR); Sungjin PARK, Suwon-si (KR); Junyung YI, Suwon-si (KR)

(21) Appl. No.: 18/869,640

(22) PCT Filed: May 12, 2023
(86) PCT No.: PCT/KR2023/006497

§ 371 Date: Nov. 26, 2024

(30) Foreign Application Priority Data
Jun. 10, 2022 (KR) 10-2022-0070762

(51) Int. Cl. H04B 7/06; H04L 5/00; H04W 24/08; H04W 72/25; H04W 76/14

(52) U.S. Cl. CPC H04B 7/06952; H04L 5/0048; H04W 24/08; H04W 72/25; H04W 76/14

(57) ABSTRACT

The present disclosure provides a beam control and beam management method required for direct communication between terminals in a wireless communication system or mobile communication system. In particular, the present disclosure proposes methods for smoothly supporting direct communication between terminals in a specific frequency band (for example, frequency range 2 (FR2)). Specifically, proposed are methods to efficiently reduce the time and amount of radio resources required for a beam detection process and a beam update process for communication between terminals, and to support the identification of beam detection failure situations and smooth progress of a new beam detection process.

### TECHNICAL FIELD

The disclosure relates to a wireless communication system or a mobile communication system. Specifically, the disclosure relates a method and a device for beam control and management controlling and managing a beam in direct communication between UEs by using beam forming, e.g., in sidelink communication.

### BACKGROUND ART

5G mobile communication technologies define broad frequency bands to enable high transmission rates and new services, and can be implemented not only in “Sub 6 GHz” bands such as 3.5 GHz, but also in ultrahigh frequency (“Above 6 GHz”) bands referred to as mmWave such as 28 GHz and 39 GHz. In addition, it has been considered to implement 6G mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

At the beginning of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mm Wave, numerology (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

With the advance of wireless communication systems, there is a need for ways to smoothly provide various services, in particular, a need to improve beam control and management methods for device-to device direct communication (i.e., sidelink).

### DISCLOSURE OF INVENTION

### Technical Problem

The disclosure is to provide a beam control and a beam management method required for direct communication between UEs in a wireless communication system or a mobile communication system. Specifically, the disclosure proposes methods for smoothly supporting direct communication between UEs in a specific frequency band (e.g., frequency range 2 (FR2).

More specifically, the disclosure proposes methods for efficiently reducing the time and amount of radio resources required for a beam detection process and a beam update process for communication between UEs, and supporting the confirmation of beam detection failure situations and smooth progress of a new beam detection process.

### Technical Solution

According to an embodiment of the disclosure for solving the above-described problems, a method performed by a first terminal is provided. The method includes receiving, from a second terminal, a first message for triggering a beam update procedure, based on a first beam quality measurement result, measuring a beam quality of the first message, in case that a second beam quality measurement result for the first message is equal to or greater than a threshold, performing a first operation for beam management with the second terminal, and in case that the second beam quality measurement result for the first message is less than the threshold, performing a second operation for beam establishment with the second terminal.

According to an embodiment of the disclosure for solving the above-described problems, a method performed by a second terminal is provided. The method includes transmitting, to a first terminal, a first message for triggering a beam update procedure, based on a first beam quality measurement result, in case that a second beam quality measurement result for the first message is equal to or greater than a threshold, performing a first operation for beam management with the first terminal, and in case that the second beam quality measurement result for the first message is less than the threshold, performing a second operation for beam establishment with the first terminal.

According to an embodiment of the disclosure for solving the above-described problems, a first terminal is provided. The first terminal includes a transceiver and a controller connected to the transceiver, and the controller is configured to receive, from a second terminal, a first message for triggering a beam update procedure, based on a first beam quality measurement result, measure a beam quality of the first message, in case that a second beam quality measurement result for the first message is equal to or greater than a threshold, performing a first operation for beam management with the second terminal, and in case that the second beam measurement result for the first message is less than the threshold, performing a second operation for beam establishment with the second terminal.

According to an embodiment of the disclosure for solving the above-described problems, a second terminal is provided. The second terminal includes a transceiver and a controller connected to the transceiver, and the controller is configured to transmit, to a first terminal, a first message for triggering a beam update procedure, based on a first beam quality measurement result, in case that a second beam quality measurement result for the first message is equal to or greater than a threshold, perform a first operation for beam management with the first terminal, and in case that the second beam quality measurement result for the first message is less than the threshold, perform a second operation for beam establishment with the first terminal.

### Advantageous Effects of Invention

According to embodiments proposed in the discourse, direct communication between UEs can be smoothly performed in a specific frequency band (e.g., FR2).

In addition, the time and amount of radio resources required for a beam detection process and a beam update process for communication between UEs can be efficiently reduced, and the confirmation of beam detection failure situations and smooth progress of a new beam detection process can be achieved.

Advantageous effects obtainable from the disclosure may not be limited to the above-mentioned effects, and other effects which are not mentioned may be clearly understood from the following descriptions by those skilled in the art to which the disclosure pertains.

### BRIEF DESCRIPTION OF DRAWINGS

FIG. 1 illustrates a base station-based beam control procedure related to an embodiment of the disclosure.

FIG. 2 illustrates a sidelink (SL) beam control method based on a base station-based beam control procedure related to an embodiment of the disclosure.

FIG. 3 an example of a beam management reference signal (BM-RS) related to an embodiment of the disclosure.

FIG. 4 illustrates a detailed procedure of a sidelink beam control method related to an embodiment of the disclosure.

FIG. 5 illustrates a sidelink beam control method according to an embodiment of the disclosure.

FIG. 6 illustrates a detailed procedure of a sidelink beam control method according to an embodiment of the disclosure.

FIG. 7 illustrates a base station-based beam failure detection (BFD) procedure and beam failure recovery (BFR) procedure related to an embodiment of the disclosure.

FIG. 8 illustrates a sidelink BFD procedure and a sidelink BFR procedure based on a base station-based BFD procedure and BFR procedure related to an embodiment of the disclosure.

FIG. 9 illustrates a sidelink BFD procedure and a sidelink BFR procedure in detail according to an embodiment of the disclosure.

FIG. 10 illustrates a structure of a UE according to an embodiment of the disclosure.

FIG. 11 illustrates a structure of a base station according to an embodiment of the disclosure.

### MODE FOR THE INVENTION

Hereinafter, exemplary embodiments of the disclosure will be described in detail with reference to the accompanying drawings. It should be noted that, in the accompanying drawings, the same or like elements are designated by the same or like reference signs, if possible. Also, a detailed description of known functions or configurations that may make the subject matter of the disclosure unnecessarily unclear will be omitted.

In describing the embodiments in the specification, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in the embodiments may include one or more processors.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description of the disclosure, terms and names defined in in the 3rd generation partnership project long term evolution (3GPP LTE) standards will be used for the sake of descriptive convenience. However, the disclosure is not limited by these terms and names, and may be applied in the same way to systems that conform other standards.

In the following description, a base station (BS) is an entity that allocates resources to terminals, and may be at least one of a next generation node B (gNode B, gNB), an evolved node B (eNode B, eNB), a Node B, a wireless access unit, a base station controller, and a node on a network. In the disclosure, the term “eNB” may be interchangeably used with the term “gNB” for the sake of descriptive convenience. That is, a base station described as “eNB” may refer to “gNB”. A terminal may include a user equipment (UE), a mobile station (MS), a cellular phone, a smartphone, a computer, or a multimedia system capable of performing a communication function. Of course, examples of the base station and the terminal are not limited to those mentioned above.

In particular, the disclosure may be applied to 3GPP NR (5th generation mobile communication standard). In addition, the disclosure may be applied to intelligent services (e.g., smart homes, smart buildings, smart cities, smart cars or connected cars, healthcare, digital education, retail business, security and safety-related services, etc.) on the basis of 5G communication technology and Internet of things (IoT)-related technology. Furthermore, the term “terminal” may refer to not only a mobile phone, an MTC device, an NB-IoT device, and a sensor, but also other wireless communication devices.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a terminal (or UE) transmits data or control signals to a base station (BS) (or eNB or gNB), and the downlink refers to a radio link via which the base station transmits data or control signals to the terminal. The above multiple access scheme separates data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

According to an embodiment, eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique may be required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km2 ) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC, which is a cellular-based mission-critical wireless communication service, may be used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 ms, and may also requires a packet error rate of 10-5 or less. Therefore, for the services supporting URLLC, a 5G system must provide a transmit time interval (TTI) shorter than those of other services, and also may require a design for assigning a large number of resources in a frequency band in order to secure reliability of a communication link.

The above-described three services considered in the 5G communication system, that is, eMBB, URLLC, and mMTC, may be multiplexed and transmitted in a single system. In this case, different transmission/reception techniques and transmission/reception parameters may be used between services in order to satisfy different requirements of the respective services. However, the above-described mMTC, URLLC, and eMBB are merely examples of different types of services, and service types to which the disclosure is applied are not limited to the above examples.

Furthermore, in the following description, LTE, LTE-A, LTE Pro, 5G (or NR), or 6G systems will be described by way of example, but the embodiments of the disclosure may also be applied to other communication systems having similar technical backgrounds or channel types. In addition, based on determinations by those skilled in the art, the embodiments of the disclosure may be applied to other communication systems through some modifications without significantly departing from the scope of the disclosure.

Upon the diversification of the types of services and the fields of wireless communication (or mobile communication), a scheme of exchanging information through direct communication between UEs is proposed, in addition to the scheme of performing communication through a central network including a base station. A scheme of direct communication between UE specified into a device to device (D2D), sidelink, etc. according to the detailed purposes and design schemes of the disclosure is advantageous in that communication can be implemented in an area in which no base station is installed, and is also advantageous in that for the purpose of communication service support requiring low performance, an operation and a structure of a communication controller can be simplified, compared to the scheme of performing communication through a central network.

After standardization of basic operations for supporting direct communication between UEs for a new radio (NR) sidelink, standardization for supporting complex operations and functions for supporting higher communication performance such as multiple-input multiple-output (MIMO) support. Moreover, the NR sidelink considers operation support in more various environments, such as carrier aggregation (CA), an unlicensed band operation, a frequency range 2 operation, etc.

All of the considerations are techniques for increasing a wireless band which can be used for sidelink communication. Specifically, the frequency range 2 operation may provide a greatly wider band compared to the conventional communication band, and thus when a proper technique for link control exists, it is advantageous in that a communication capacity through a sidelink, e.g., a data rate for each communication or the number of UEs performing sidelink can be greatly increased. It is predicted that the increase in the wireless sensor communication consumption represented by a smart factory, etc. and the increase in the use of a personal small wireless portable device represented by a wearable device, etc. will require the increase in a sidelink communication capacity, and thus a technique of direct communication between UEs in a frequency range 2 area, specifically, a sidelink communication technique needs to be enhanced.

The disclosure proposes a method for controlling and managing a communication beam between UEs, which corresponds to an essential technique for supporting a sidelink operation in a frequency range 2 area, and proposes methods for a procedure (e.g., beam failure recovery (BFR)) for switching to a new beam in a case of sidelink beam control failure (e.g., beam failure detection (BFD)). The technique proposed in the disclosure is not limited to the sidelink, and is applicable to various schemes for supporting direct communication between UEs.

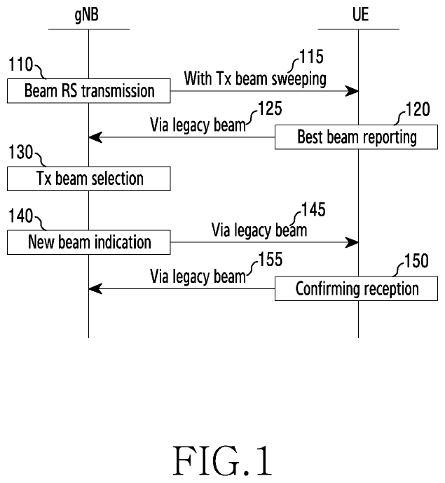

FIG. 1 illustrates a based station-based beam control procedure related to an embodiment of the disclosure.

A frequency range 2 (hereinafter, FR2) frequency band may provide a wider available bandwidth than the conventional communication band, and upon the advantages, research on the usage is conducted as a band supporting various communication services of the 5G. FR2 requires communication through beamforming to overcome relatively strong path attenuation. To this end, the FR2 communication scheme operating based on the base station is performed through the procedures in which when the UE transmits a beam reference signal (beam measurement reference signal, referred to as “BM-RS” or “beam RS”) of the base station to the UE through transmission beam sweeping (110 and 115) and the UE reports, based on a result of receiving the beam reference signal, a proper (or the best) beam to the base station (120 and 125), the base station finally determines a transmission beam and notifies the UE of the same (130, 140, and 145). The base station may respond to the base station that a result of the finally determined beam is normally received (150 and 155). Such a series of procedures is illustrated in FIG. 1.

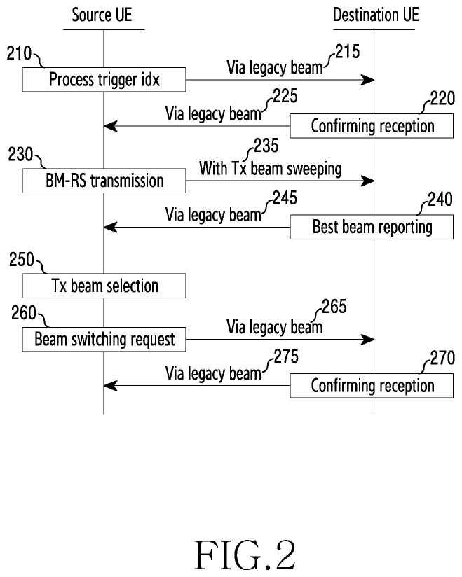

FIG. 2 illustrates a sidelink (SL) beam control method based on a base station-based beam control procedure related to an embodiment of the disclosure.

Recently, a method for supporting sidelink-based direct communication between UEs is being discussed, and the method inevitably requires introduction of a beam management technique between the UEs. Unlike the case of the base station-based communication, periodic transmission of a reference signal (RS) is difficult in the communication between UEs, and thus the UE transmits a reference signal required for beam control when it is determined that beam measurement and updating are required.

Specifically, when direct communication is performed between two UEs, one UE may be considered as a source UE, another UE may be considered as a destination UE, hereinafter, for convenience of description, the source UE is called a first UE, and the destination UE is called a second UE.

FIG. 2 illustrates a beam control scheme for sidelink (or direct communication between UEs), in which a process of transmitting and receiving a signal for a beam modification request is added to the base station-based beam control scheme described in FIG. 1. In FIG. 2, a source UE having determined to require beam modification or beam updating transfers information (or an index) for initiation or triggering of a beam modification (or beam update) procedure (210 and 215), and the destination UE responds to the source UE that such information (or index) has been received (220 and 225). Thereafter, the processes of transmitting a beam reference signal between the source UE and the destination UE (230 and 235), reporting a result of the reception (240 and 245), and determining a new beam may be performed (250, 260, 265, 270, and 275), and the operation between two UEs may be performed in the similar form to the procedure between the base station and the UE, described in FIG. 1.

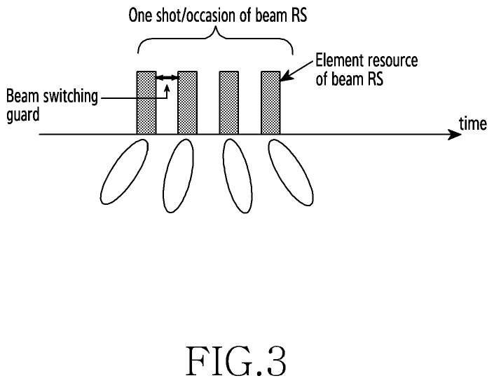

FIG. 3 illustrates an example of a beam management reference signal (BM-RS) related to an embodiment of the disclosure.

In transmitting the BM-RS for beam control and updating, the BM-RS is transmitted such that a reception UE (e.g., a UE or a destination UE) receives the BM-RS in multiple beams and selects and reports a proper one beam or multiple beams. Accordingly, the BM-RS is transmitted in the scheme of repeatedly transmitting multiple RS through different transmission beams on radio resources having the same structure. The scheme is defined as transmission beam sweeping or Tx beam sweeping procedure. FIG. 3 illustrates an example of a transmission process through Tx beam sweeping of the BM-RS utilized in the conventional beam control scheme. It is normal that a latency or a guard interval is required during beam switching for transmission beam sweeping, and the size of the latency and the guard interval may vary according to the performance of a transmission UE.

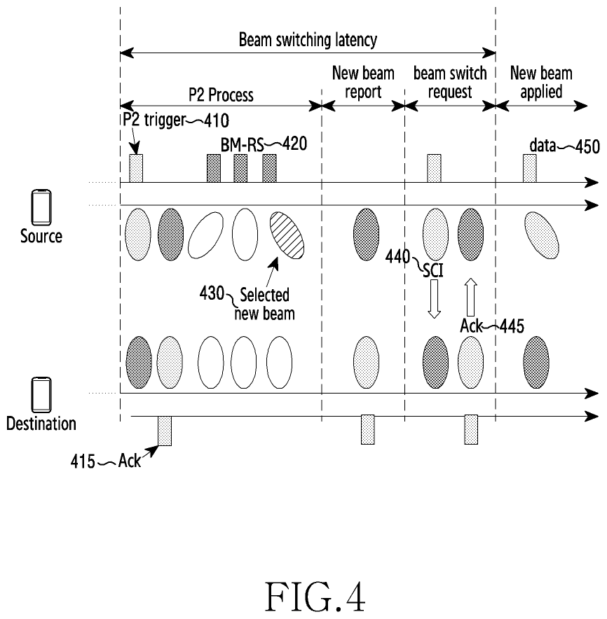

FIG. 4 illustrates a specific procedure of a sidelink beam control method related to an embodiment of the disclosure.

Accordingly, when the BM-RS transmitted according to the Tx beam sweeping procedure is applied to the sidelink beam control process between UEs as described in FIG. 2, the signal transmission and reception process between the source UE and the destination UE may be performed as illustrated in FIG. 4.

According to the details described in FIG. 2 and the illustration in FIG. 4, a beam switching latency occurs due to specific procedures to be described below. As a first operation, an operation of making a request by the source UE (P2 trigger 410 of FIG. 4) and accepting the request by the destination UE (Ack 415 of FIG. 4) is performed. As a second operation, an operation of transmitting a BM-RS through Tx beam sweeping by the source UE and receiving the BM-RSs by the destination UE is performed (420). As a third operation, an operation of selecting one or multiple new beams by the destination UE (430), and reporting the same to the source UE is performed (new beam report of FIG. 4). As a fourth operation, an operation of finally determining, based on the one or multiple new beams reported by the destination UE, a beam to be applied to the sidelink by the source UE, notifying the destination UE of the same through sidelink control information (SCI) (440), and transmitting a confirmation response to the process to the source UE by the destination UE (445) is performed (beam switch request of FIG. 4). Thereafter, the source UE and the destination UE may perform direct communication between UEs by applying the newly determined new beam and exchange data (new beam applied 450 of FIG. 4). All of the operations require signal or message transmission and reception between the source UE and the destination UE. Accordingly, the entire latency for beam switching (beam switching latency of FIG. 4) may be greatly increased as there are a large number of operations required for a series of procedures or there are a large number of signal transmission and reception operations performed in each operation in consideration of characteristics of sidelink (or direct communication between UEs) in which communication is performed using only pre-configured or restricted radio resources.

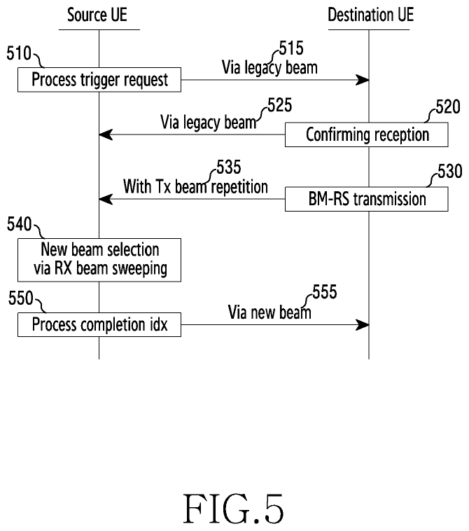

FIG. 5 illustrates a sidelink beam control method according to an embodiment of the disclosure.

According to an embodiment proposed in the disclosure, the number of process operations or processes of a beam switching operation used for sidelink (or direct communication between UEs) may be reduced, and the time and the number of radio resources required for BM-RS transmission and new beam measurement may be reduced.

According to the method proposed in FIG. 5, when the source UE determines that beam modification or beam updating is required, the source UE transmits information requesting (or indication) the initiation or triggering of the beam modification (or beam updating) procedure to the destination UE (510 and 515). When the destination UE accept the request (or indication) received from the source UE (520 and 525), the destination UE, rather than the source UE, performs BM-RS transmission to the source UE (530 and 535). In other words, the destination UE corresponding to an entity having received the initiation or triggering request of the beam modification (or beam updating) procedure may transmit a result of the reception of the request in response to the source UE (520 and 525), and then directly transmit the BM-RS to the source UE (530 and 535). In addition, in transmitting the BM-RS to the source UE, the destination UE may not perform the Tx beam sweeping operation, and repeatedly transmit the BM-RS by using the same beam (e.g., Tx beam repetition) (535). Through this process, the destination UE may avoid the latency or the guard duration required during the repetition transmission of the BM-RS, the radio resource and the entire time required for BM-RS transmission may be greatly reduced. The source UE having received the BM-RS transmitted from the destination UE may perform Rx beam sweeping during the BM-RS reception, and select the optimal (or best) beam (540). Thereafter, the source UE may immediately apply a new beam newly selected for communication with the destination UE. In other words, the source UE may use the newly selected new beam when transmitting a message for indicating process completion of the beam modification (or beam updating) with the destination UE to the destination UE (550 and 555). The reason why such prompt beam switching is possible is because in selecting a new beam by the source UE, all information on the beam is considered only by the source UE, the destination UE only performs BM-RS repetition transmission through the existing beam, and thus the beam modification (or beam updating) by the source UE does not influence the beam configuration operation of the destination UE.

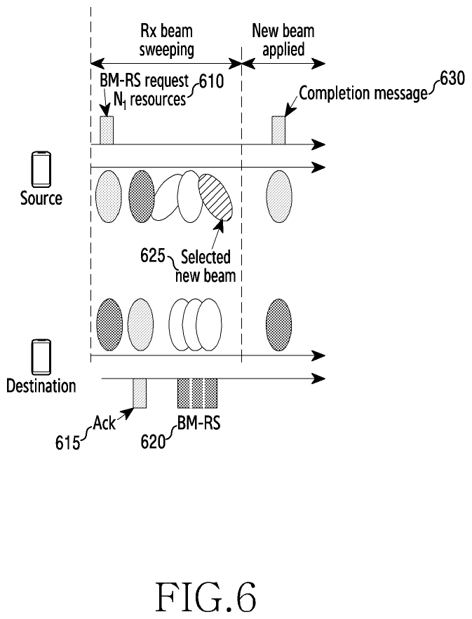

FIG. 6 illustrates a specific procedure of a sidelink beam control method according to an embodiment of the disclosure.

FIG. 6 illustrates an example of a signal transmission and reception process according to a beam control procedure according to the embodiment described in FIG. 5. According to the process described in FIG. 6, the source UE may perform an Rx beam sweeping operation which can be performed without the latency or guard duration, instead of performing the Tx beam sweeping requiring the latency or guard duration during the BM-RS repetition transmission (Rx beam sweeping of FIG. 6) (610, 615, 620, 625, and 630). Through this procedure, the amount of radio resources and the time required for new beam determination and BM-RS transmission and reception between the source UE and the destination UE may be reduced, and the operations, described in FIG. 4, of reporting the new beam to the source UE by the destination UE and indicating the new beam to the destination UE by the source UE are omitted, and thus the entire latency time and the amount of radio resources required for beam switching for communication between UEs can be greatly reduced.

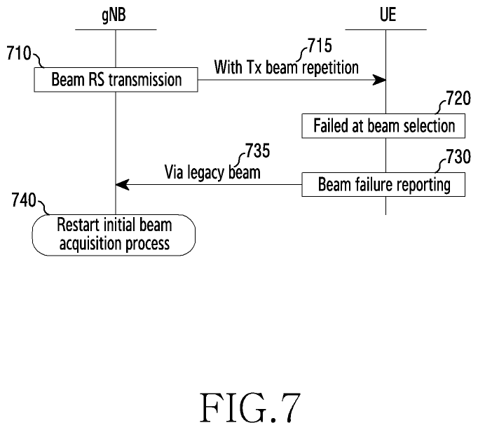

FIG. 7 illustrates a base station-based beam failure detection (BFD) procedure and beam failure recovery (BFR) procedure related to an embodiment of the discourse.

As another embodiment of the disclosure, a BFD and a BFR procedure occurring in the sidelink (or communication between UEs) may be performed based on the beam modification (or beam updating) procedure described in FIGS. 5 and 6 above. According to the embodiment, compared to the conventional BFD and BFR procedures, the radio resource efficiency can be increased and the latency can be reduced. The conventional BFD procedure is performed at a UE end in a situation of communication between a base station and a UE, is performed at a reception end in a situation of communication between a transmission end and the reception end, and is performed through a procedure of reporting the BFD result to the base station or the transmission end by the UE or the reception end. Thereafter, the BFR procedure is performed through a process of performing the initial beam configuration operation again by the base station or the transmission end. FIG. 7 illustrates the BFD and BFR procedures, and in FIG. 7, the base station transmits a beam-related RS to the UE (710 and 715), when detecting failure in the beam selection process (720), the UE reports the beam failure to the base station (730 and 735), and the base station starts again the initiation beam acquisition procedure (740).

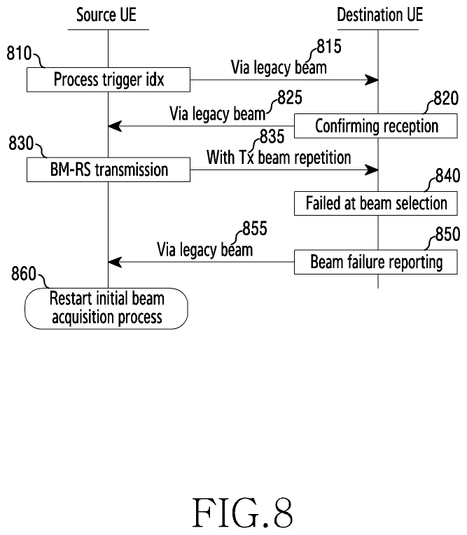

FIG. 8 illustrates a sidelink BFD procedure and sidelink BFR procedure based on a base station-based BFD procedure and BFR procedure related to an embodiment of the disclosure. FIG. 8 illustrates a process of applying the BFD and BFR procedures between the base station and the UE, described in FIG. 7, to the sidelink (or direct communication between UEs).

In FIG. 8, the beam modification (or beam updating) operation is started (810 and 815) by transmitting, from the source UE to the destination UE, an indication (or an index) for notifying of the triggering (or the start) of the beam modification (or beam updating) procedure. The destination UE having received the indication or index transmits a reception confirmation response to the source UE (820 and 825), and then the source UE transmits the BM-RS to the destination UE (830 and 835). When the destination UE fails to detect or select a new beam in the process of receiving the BM-RSs repeatedly transmitted by the source UE, the destination UE reports the beam failure detection to the source UE so that the BFD procedure is performed (840). Thereafter, the BFR procedure between the source UE and the destination UE is performed (850 and 855), and the source UE may restart the initial beam acquisition procedure (860). Similar to the sidelink beam modification (or beam updating) method utilizing the conventional scheme as described in FIG. 2, in the scheme of FIG. 8, not only a large number of radio resources and time delay are caused in Tx beam sweeping of the BM-RS but also whether there is beam failure is determined according to beam performed measured by the destination UE rather than the beam performance of the source UE even though the beam modification is requested by the source UE, and thus the improvement may be required from the perspective of the BFD accuracy.

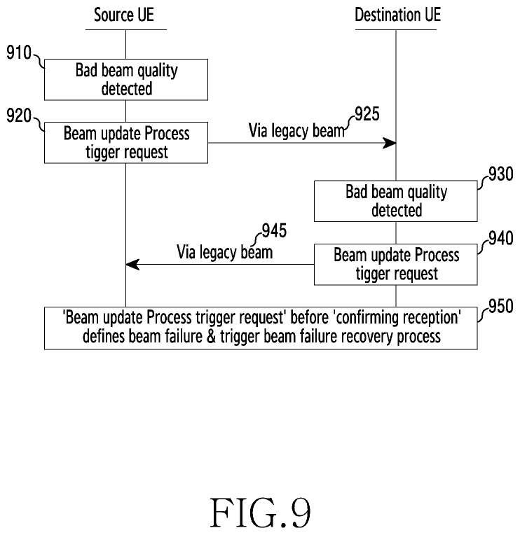

FIG. 9 illustrates a sidelink BFD procedure and a sidelink BFR procedure in detail according to an embodiment of the disclosure.

FIG. 9 illustrates a BFD and a BFR procedure according to an embodiment proposed in the disclosure. When the source UE determines that a beam quality is equal to or less than a threshold value and determines that beam modification (or beam updating) is required (910), the source UE may transmit, to the destination UE, information or an index for requesting the start (or triggering) of the beam modification (or beam updating) operation (920 and 925). The destination UE having received the request or index from the source UE is not explicitly illustrated in FIG. 9, but BM-RS transmission may be initiated according to the embodiment proposed in FIG. 5. Alternatively, the destination UE having received the request or index from the source UE may transfer, to the source UE, information indicating that the beam performance or the beam quality measured by the destination UE is low, as in the embodiment illustrated in FIG. 9, and the transferring process may be performed by transmitting information or an index for requesting the start (or triggering) of the beam modification (or beam updating) operation (930, 940, and 945). When the destination UE transmits the request, it may mean a situation in which modification or updating is required for both a destination UE beam and a source UE beam, and thus the two UEs may interpret the same as the occurrence of beam failure and start the initial beam configuration operation (950). According to the scheme, the source UE or the destination UE may initiate a procedure for beam failure recovery without receiving a separate confirmation response after requesting the initiation of the beam notification (or beam updating) procedure, and thus the scheme is advantageous in that the BFD can be performed without a procedure required for the BM-RS transmission, compared to the scheme described in FIG. 8. In addition, the scheme is advantageous in that beam failure is defined in consideration of both the source UE beam performance and the destination UE beam performance.

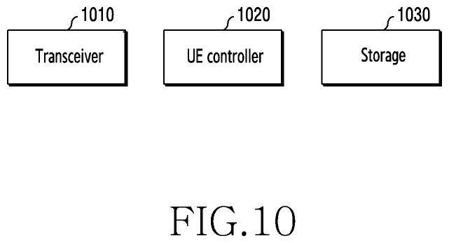

FIG. 10 illustrates a structure of a UE according to an embodiment of the disclosure. The UE of FIG. 10 may include not only a UE communicating with a base station, but also a source UE (or a first UE) or a destination UE (or a second UE) as described above.

Referring to FIG. 10, the UE may include a transceiver 1010, a UE controller 1020, and a storage 1030. As used herein, the UE controller 1020 may be defined as a circuit, an application specific integrated circuit, or at least one processor.

The transceiver 1010 may transmit/receive signals with other network entities. The transceiver 1010 may receive beam control-related signals from a base station and report results of beam control procedures, and may transmit or receive beam control-related signals or messages to a counterpart UE (peer UE).

The UE controller 1020 may control the overall operation of the UE according to the embodiments proposed in the disclosure. For example, the UE controller 1020 may control signal flows between the respective blocks to perform operations according to the above-described flowcharts. Specifically, the UE controller 1020 may operate according to control signals from the base station, and may exchange messages or signals with other UEs and/or the base station.

The storage 1030 may store at least one of information transmitted/received through the transceiver 1010 and information generated through the UE controller 1020.

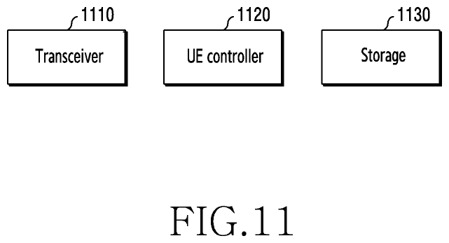

FIG. 11 illustrates a structure of a base station according to an embodiment of the disclosure.

Referring to FIG. 11, the base station may include a transceiver 1110, a base station controller 1120, and a storage 1130. As used herein, the base station controller 1120 may be defined as a circuit, an application specific integrated circuit, or at least one processor.

The transceiver 1110 may transmit/receive signals with other network entities. Ther transceiver may transmit/receive, for example, beam control-related signals to the UE.

The base station controller 1120 may control the overall operation of the base station according to the embodiments proposed in the disclosure. For example, the base station controller 1120 may control signal flows between the respective blocks to perform operations according to the above-described flowcharts. Specifically, the base station controller 1120 may transmit beam control-related signals to the UE and receive reports of the result thereof for the sake of smooth communication of the UE.

The storage 1130 may store at least one of information transmitted/received through the transceiver 1110 and information generated through the base station controller 1120.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

In addition, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. For example, a part or all of an embodiment may be combined with a part or all of one or more other embodiments, and it is natural that an implementation of such combination also corresponds to an embodiment proposed by the disclosure. For example, all or part of an embodiment may be combined with all or part of one or more other embodiments, which also falls within the scope of the disclosure. Therefore, the scope of the disclosure should not be defined as being limited to the embodiments set forth herein, but should be defined by the appended claims and equivalents thereof.

1. A method performed by a first terminal of a wireless communication system, the method comprising:
receiving, from a second terminal, a first message for triggering a beam update procedure, based on a first beam quality measurement result;
measuring a beam quality of the first message;
in case that a second beam quality measurement result for the first message is equal to or greater than a threshold, performing a first operation for beam management with the second terminal; and
in case that the second beam quality measurement result for the first message is less than the threshold, performing a second operation for beam establishment with the second terminal.

2. The method of claim 1, wherein the first operation comprises:
transmitting a beam management reference signal to the second terminal through transmission beam repetition; and
receiving, from the second terminal, information indicating completion of the beam management through a beam selected according to reception beam sweeping.

3. The method of claim 1, wherein the second operation comprises:
determining beam failure; and
performing an initial beam configuration procedure for communication with the second terminal.

4. The method of claim 1, wherein the first terminal is a source terminal of sidelink communication and the second terminal is a destination terminal of the sidelink communication.

5. A method performed by a second terminal of a wireless communication system, the method comprising:
transmitting, to a first terminal, a first message for triggering a beam update procedure, based on a first beam quality measurement result;
in case that a second beam quality measurement result for the first message is equal to or greater than a threshold, performing a first operation for beam management with the first terminal; and
in case that the second beam quality measurement result for the first message is less than the threshold, performing a second operation for beam establishment with the first terminal.

6. The method of claim 5, wherein the first operation comprises:
receiving, from the first terminal, a beam management reference signal transmitted according to transmission beam repetition; and
transmitting, to the first terminal, information indicating completion of the beam management through a beam selected according to reception beam sweeping.

7. The method of claim 5,
wherein the second operation comprises upon determination of beam failure, performing an initiation beam configuration procedure for communication with the first terminal, and
wherein the first terminal is a source terminal of sidelink communication and the second terminal is a destination terminal of the sidelink communication.

8. A first terminal of a wireless communication system, the first terminal comprising:
a transceiver; and
a controller connected to the transceiver,
wherein the controller is configured to:
receive, from a second terminal, a first message for triggering a beam update procedure, based on a first beam quality measurement result,
measure a beam quality of the first message,
in case that a second beam quality measurement result for the first message is equal to or greater than a threshold, performing a first operation for beam management with the second terminal, and
in case that the second beam measurement result for the first message is less than the threshold, performing a second operation for beam establishment with the second terminal.

9. The first terminal of claim 8, wherein the first operation comprises transmitting a beam management reference signal to the second terminal through transmission beam repetition, and receiving, from the second terminal, information indicating completion of the beam management through a beam selected according to reception beam sweeping.

10. The first terminal of claim 8, wherein the second operation comprises determining beam failure, and performing an initial beam configuration procedure for communication with the second terminal.

11. The first terminal of claim 8, wherein the first terminal is a source terminal of sidelink communication and the second terminal is a destination terminal of the sidelink communication.

12. A second terminal of a wireless communication system, the second terminal comprising:
a transceiver; and
a controller connected to the transceiver,
wherein the controller is configured to:
transmit, to a first terminal, a first message for triggering a beam update procedure, based on a first beam quality measurement result,
in case that a second beam quality measurement result for the first message is equal to or greater than a threshold, perform a first operation for beam management with the first terminal, and
in case that the second beam quality measurement result for the first message is less than the threshold, perform a second operation for beam establishment with the first terminal.

13. The second terminal of claim 12, wherein the first operation comprises receiving, from the first terminal, a beam management reference signal transmitted according to transmission beam repetition, and transmitting, to the first terminal, information indicating completion of the beam management through a beam selected according to reception beam sweeping.

14. The second terminal of claim 12, wherein the second operation comprises upon determination of beam failure, performing an initiation beam configuration procedure for communication with the first terminal.

15. The second terminal of claim 12, wherein the first terminal is a source terminal of sidelink communication and the second terminal is a destination terminal of the sidelink communication.
